(19) United States
(12) Patent Application Publication
(10) Pub. No.: US 2005/0251961 A1
(43) Pub. Date: Nov. 17, 2005

(54) Adjustable hinge structure

(76) Inventor: Hsu-Nan Liu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/082,662

(22) Filed: Mar. 18, 2005

(30) Foreign Application Priority Data
May 13, 2004 (TW) 093207438

(51) Int. Cl. F16M 3/00

(52) U.S. Cl. 16/242

(57) ABSTRACT

An adjustable hinge structure includes a fixture, a bracket, a first adjusting element, a securing plate and a second adjusting element. The fixture comprises a connecting plate for the bracket to be secured thereon. A securing end of the first adjusting element is inserted through a first hole of the connecting plate and a first through hole of the bracket to adjust the position of the bracket with respect to the fixture. The securing plate is pivotally connected to the bracket, with the second adjusting element inserting through a second hole of the bracket and a second through hole of the securing plate to adjust the position of the bracket with respect to the securing plate.

### BACKGROUNF OF THE INVENTION

1. Field of the Invention

This invention relates to an adjustable hinge structure, and more particularly to a hinge using a pair of adjusting elements to adjust the positions of a bracket with respect to a fixture and a securing plate, respectively.

2. Description of the Prior Art

Most closets use hinges to open or to close their doors. Mounting the hinge to the door requires drilling holes in a precision position, or the door cannot be closed or opened. It is necessary to release the hinges first and then to drill holes anew. The holes left on the door make the looking in bad shape.

In view of this shortcoming, the inventor has derived the present invention, which facilitates installation of the hinge and is easy to operate.

### SUMMARY OF THE INVENTION

It is the primary objective of the present invention to provide an adjustable hinge structure, which bracket is adjustable in position with respect to a fixture and a securing plate.

It is another objective of the present invention to provide an adjustable hinge structure, which provides a fine adjustment when it is out of alignment, so as to prevent from drilling holes anew.

It is another objective of the present invention to provide an adjustable hinge structure, which is easy to make an adjustment.

### BRIEF DESCRIPTION OF THE DRAWINGS

FIG. 1 is an exploded view of the present invention;

FIG. 2 is a perspective view of the present invention;

FIG. 3 is an enlarged view of a first adjusting element of the present invention, partially sectioned;

FIG. 4 is a perspective view showing that the present invention is mounted to a closet and its door;

FIG. 5 is an enlarged view of FIG. 4;

FIG. 6 is a view similar to FIG. 3 in an operating status; and

FIG. 7 is an enlarged view of a second adjusting element of the present invention.

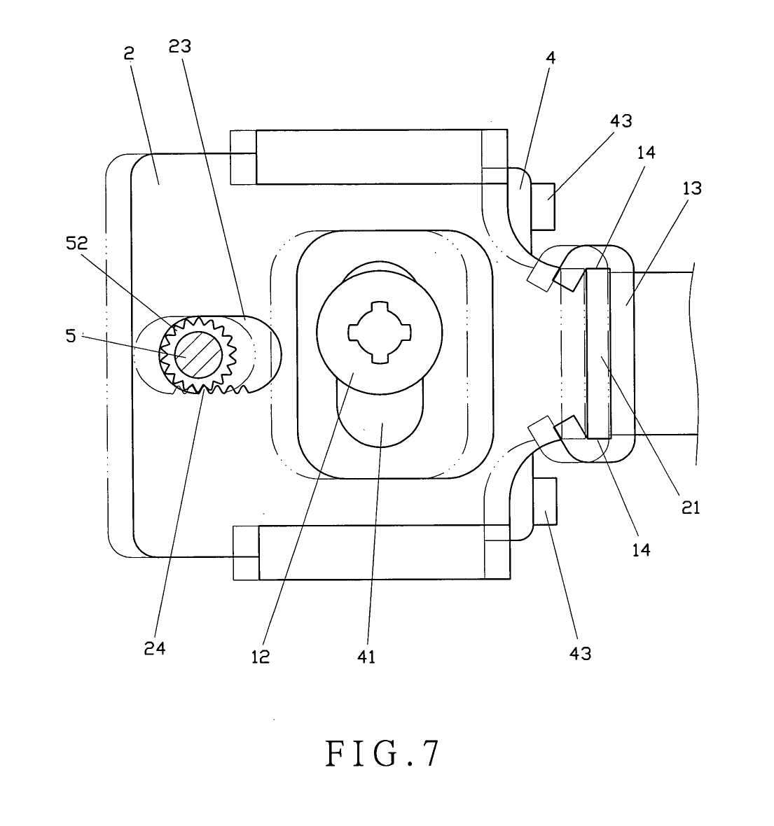

### DETAILED DESCRIPTION OF THE PREFERRED EMBODIMENT

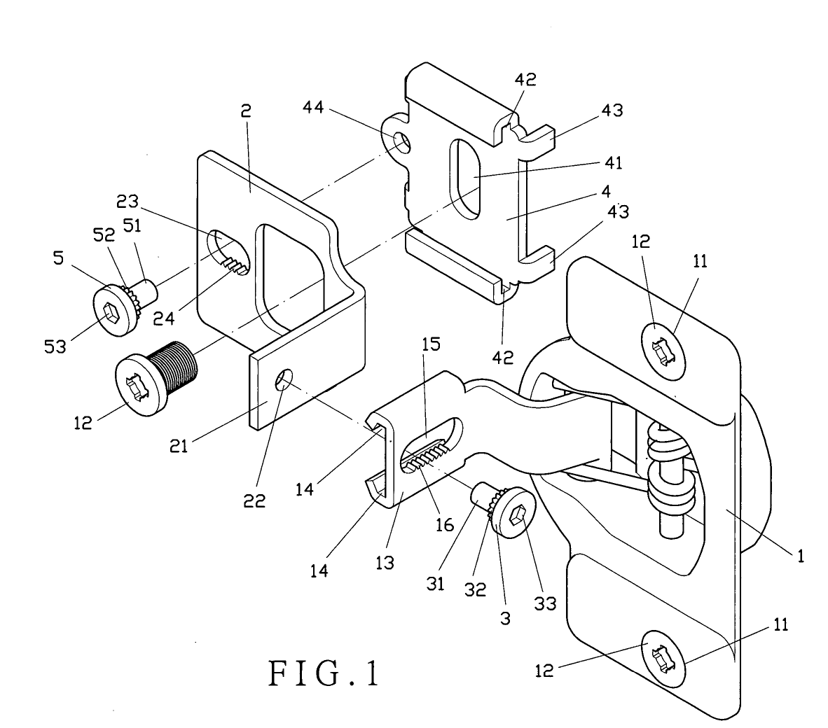

As shown in FIG. 1, the present invention comprises a fixture 1, a bracket 2, a first adjusting element 3, a securing plate 4, and a second adjusting element 5.

The fixture 1 comprises a pair of holes 11 at the top and the bottom ends for a pair of bolts 12 to insert there through. A connecting plate 13 is pivotally connected to one side of the fixture 1. The connecting plate 13 has a pair of first slots 14 on the top and the bottom ends thereof. The connecting plate 13 is formed with a first hole 15 having teeth 16 on one inner edge thereof.

The bracket 2 comprises a side block 21 to be inserted into the first slots 14 of the connecting plate 13 of the fixture 1. The side block 21 comprises a first through hole 22. The bracket 2 is formed with a second hole 23 having teeth 24 on one inner edge thereof.

The first adjusting element 3 is inserted into the first hole 15 of the connecting plate 13 and the first through hole 22 of the side block 21. The first adjusting element 3 may be a rivet or a bolt. The first adjusting element 3 comprises a securing end 31 having teeth 32 around the periphery and an adjusting end 33 at the opposite end thereof.

The securing plate 4 secured to the bracket 2 is formed with a fixing hole 41 for a bolt 12 to insert there through. The securing plate 4 comprises a pair of second slots 42 on the top and the bottom ends, two pairs of securing ankles 43 extending backward from respective sides, and a second through hole 44 thereof.

The second adjusting element 5 is inserted into the second hole 23 of the bracket 2 and the second through hole 44 of the securing plate 4. The second adjusting element 5 may be a rivet or a bolt. The second adjusting element 5 comprises a securing end 51 having teeth 52 around the periphery and an adjusting end 53 at the opposite end thereof.

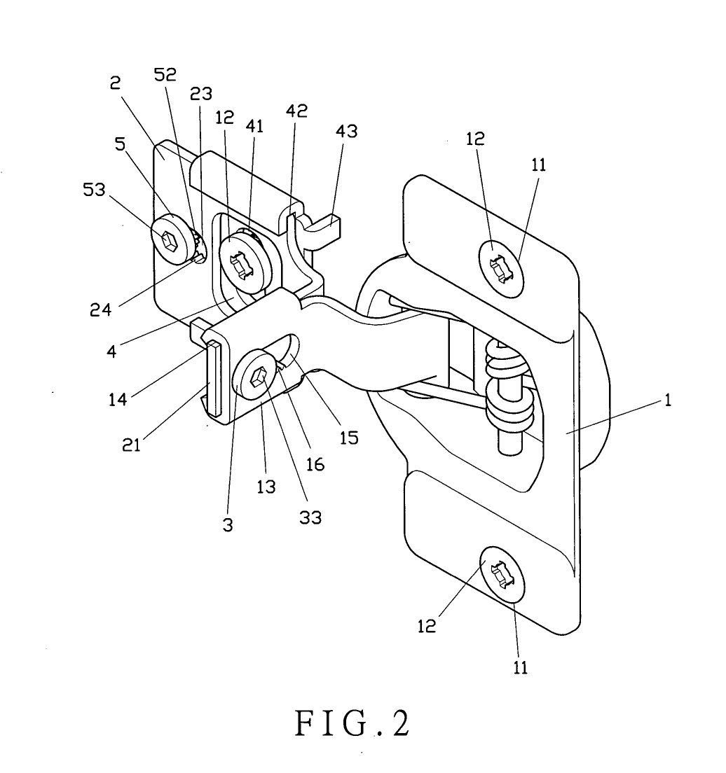

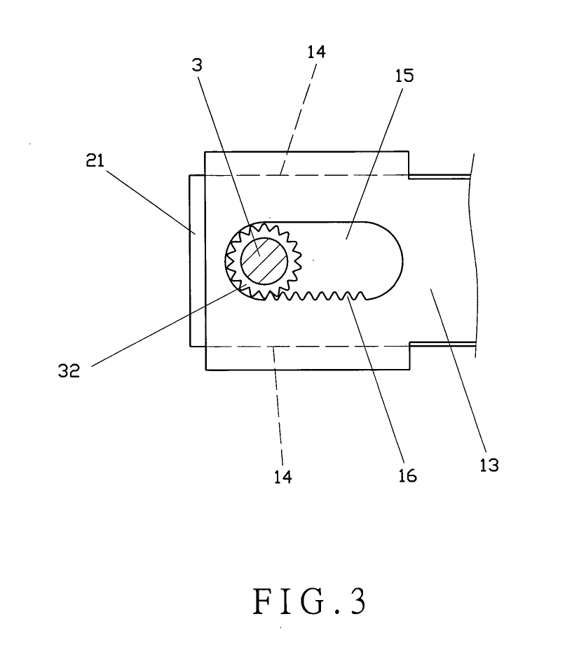

To assemble the present invention, as shown in FIG. 2, the side block 21 of the bracket 2 is inserted into the first slots 14 of the fixture 1. The first adjusting element 3 is inserted into the first hole 15 of the connecting plate 13 and the first through hole 22 of the side block 21 with the securing end 31 protruding outwardly from the first through hole 22 and being riveted thereat to secure the connecting plate 13 and the side block 21 in place. The teeth 32 on the securing end 31 of the first adjusting element 3 mesh with the teeth 16 of the first hole 15 of the connecting plate 13, as shown in FIG. 3. By screwing the adjusting end 33 of the first adjusting element 3, the side block 21 may be slid along the first slots 14 of the connecting plate 13 transversely.

The bracket 2 is inserted into the second slots 42 of the securing plate 4. The second adjusting element 5 is inserted into the second hole 23 of the bracket 2 and the second through hole 44 of the securing plate 4 with the securing end 51 protruding outwardly from the second through hole 44 and being riveted thereat to secure the bracket 2 and the securing plate 4 in place. The teeth 52 on the securing end 51 mesh with the teeth 24 of the second hole 23. By screwing the adjusting end 53 of the adjusting element 5, the bracket 2 may be slid along the second slots 42 of the securing plate 4.

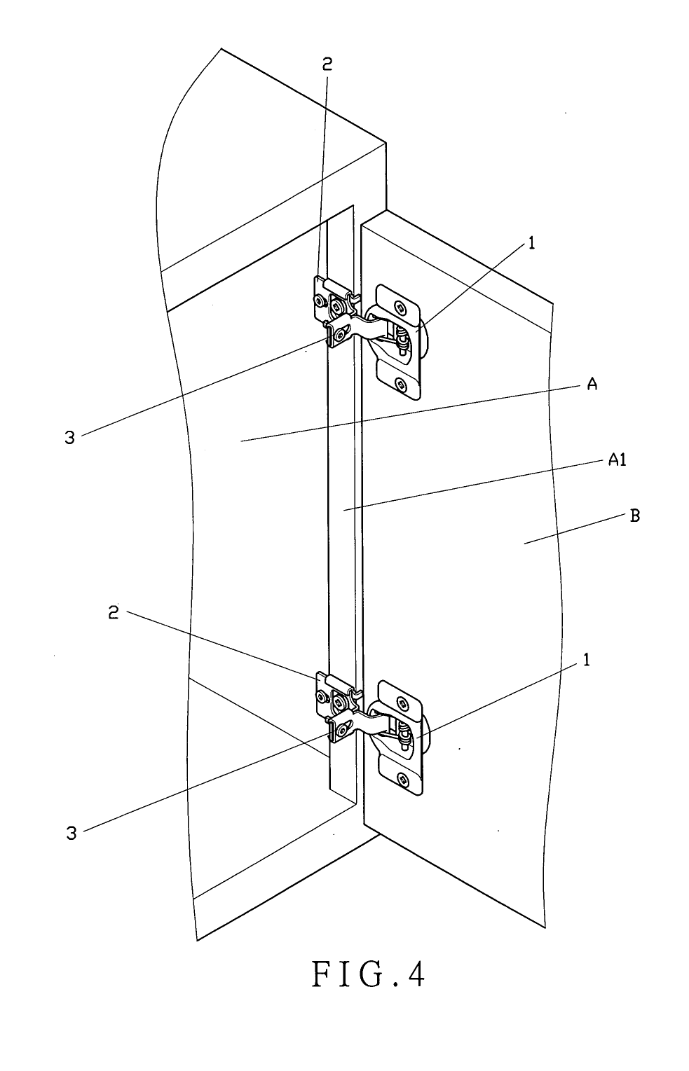

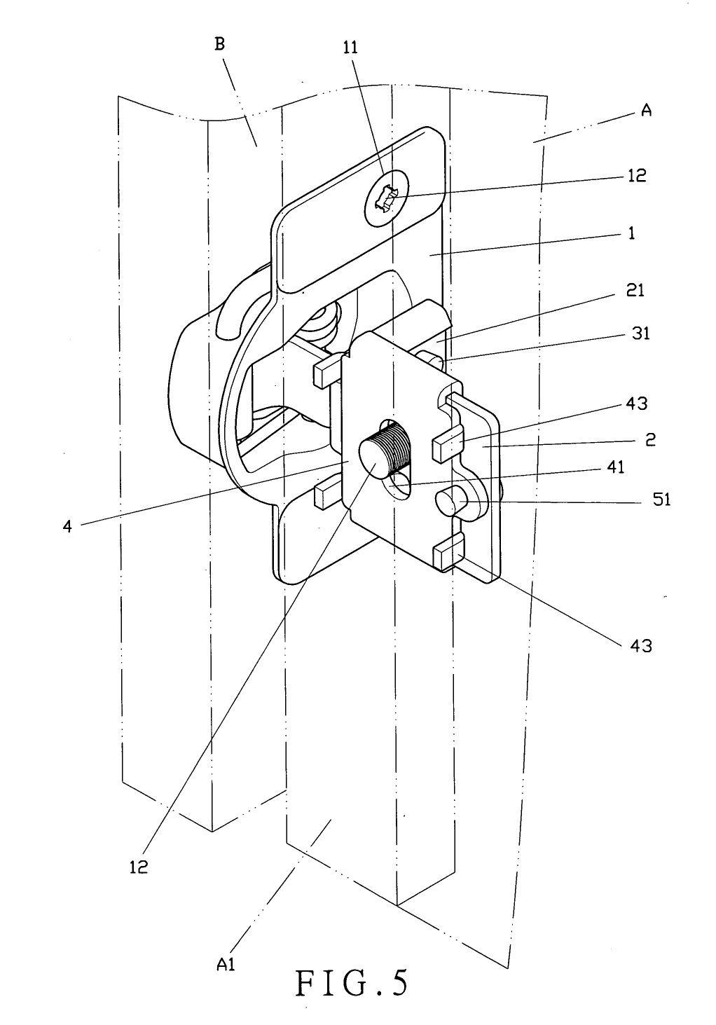

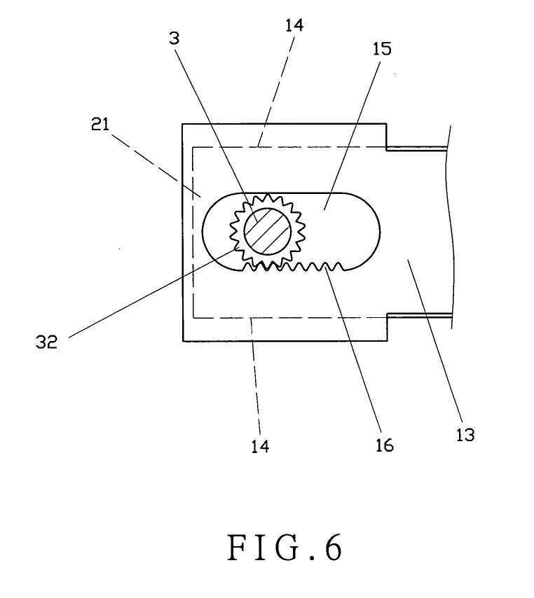

In practice, as shown in FIGS. 2, 4 and 5, the securing plate 4 is mounted to an inner ridge A1 of a closet A by means of the bolt 12 inserting through the fixing hole 41, with the securing ankles 43 clamping the two sides of the ridge A1. The fixture 1 is mounted to the inner edge of a door B with the bolts 12 inserting through the holes 11. The door B may be swung to open and close by means of the connecting plate 13. If there is a miscalculated position of the fixture 1, the bracket 2 and the securing plate 4, it is not easy to open or close the door. As shown in FIG. 6, the adjusting end 33 of the first adjusting element 3 is adjusted with a tool so that the teeth 32 of the securing end 31 may be slid along the teeth 16 of the first hole 15. Thus the side block 21 of the bracket 2 may be slid along the first slots 14 of the connecting plate 13 to adjust the position. If the miscalculation is caused by the securing plate 4, the adjusting end 53 of the adjusting element 5 is adjusted with a tool so that the teeth 52 of the securing end 51 may be slid along the teeth 24 of the second hole 23. Thus the bracket 2 may be slid along the second slots 42 of the securing plate 4.

1. An adjustable hinge structure comprising:
a fixture, said fixture comprising a connecting plate;
a bracket, said bracket being connected to said connecting plate of said fixture;
a securing plate, said securing plate being connected said bracket, and characterized in that:
said connecting plate comprising a pair of first slots and a first hole, said bracket comprising a side block and a second hole, said side block comprising a first through hole, said securing plate comprising a pair of second slots and a second through hole; a first adjusting element comprising a securing end and an adjusting end, said securing end being inserted into said first hole of said connecting plate and said first through hole of said side block for adjusting said fixture and said bracket in position; a second adjusting element comprising a securing end and an adjusting end, said securing end being, inserted into said second hole of said bracket and said second through hole of said securing plate for adjusting said bracket and said securing plate in position.

2. The adjustable hinge structure, as recited in claim 1, wherein said first hole comprises teeth on an inner edge, and said securing end of said first adjusting element comprises teeth around the periphery to be meshed with said teeth of said first hole.

3. The adjustable hinge structure, as recited in claim 1, wherein said second hole comprises teeth on an inner edge, and said securing end of said second adjusting element comprises teeth around the periphery to be meshed with said teeth of said second hole.

4. The adjustable hinge structure, as recited in claim 1, wherein said first adjusting element and said second adjusting element are rivets, having front edges of the securing ends to be riveted.
